(19) United States
(12) Patent Application Publication
(10) Pub. No.: US 2026/0170857 A1
(43) Pub. Date: Jun. 18, 2026

(54) WARNING APPARATUS, SYSTEM, AND METHOD, AND COMPUTER-READABLE MEDIUM

(71) Applicant: NEC Corporation, Minato-ku, Tokyo (JP)

(72) Inventor: Tomoki KITAHORI, Tokyo (JP)

(73) Assignee: NEC Corporation, Minato-ku, Tokyo (JP)

(21) Appl. No.: 19/124,976

(22) PCT Filed: Nov. 25, 2022
(86) PCT No.: PCT/JP2022/043463

§ 371 Date: Apr. 28, 2025

(51) Int. Cl. G06V 30/10

(52) U.S. Cl. CPC G06V 30/10

(57) ABSTRACT

A warning apparatus includes: at least one memory storing instructions, and at least one processor configured to execute the instructions to; recognize a region included in an image obtained by imaging surroundings of a traveling vehicle; determine whether or not character recognition is necessary, on the basis of a type of the recognized region; perform the character recognition on the recognized region in a case where it is determined that the character recognition is necessary; determine whether or not a warning is necessary, on the basis of a result of the character recognition and specification information of the vehicle; and output warning information in a case where it is determined that the warning is necessary.

### TECHNICAL FIELD

The present disclosure relates to a warning apparatus, a system, a method, and a program.

### BACKGROUND ART

Patent Literature 1 discloses a technique related to a driving assistance apparatus that detects traffic restriction information regarding a vehicle from image information supplied by a front camera of the vehicle, generates notification information on the basis of vehicle specification information and the traffic restriction information, and notifies a driver of the vehicle of the notification information. Patent Literature 2 discloses a technique related to a vehicle alert apparatus. The vehicle alert apparatus according to Patent Literature 2 measures a height of an elevated structure of a road by emitting a laser beam from a traveling vehicle, determines whether the vehicle can pass under the elevated structure on the basis of a measurement result, and issues an alert on the basis of a determination result.

### CITATION LIST

### Patent Literature

Patent Literature 1: Japanese Unexamined Patent Application Publication No. 2014-006707

Patent Literature 2: Japanese Unexamined Patent Application Publication No. 2021-077201

### SUMMARY OF THE INVENTION

### Technical Problem

Here, higher accuracy is required for a technique of issuing a warning to avoid an accident of a traveling vehicle.

In view of the above-described problem, an object of the present disclosure is to provide a warning apparatus, a system, a method, and a program for improving accuracy of a warning regarding a traveling vehicle.

### Solution to Problem

A warning apparatus according to a first aspect of the present disclosure includes:
a region recognition means for recognizing a region included in an image obtained by imaging surroundings of a traveling vehicle;
a first determination means for determining whether or not character recognition is necessary, on the basis of a type of the recognized region;
a character recognition means for performing the character recognition on the recognized region in a case where it is determined that the character recognition is necessary;
a second determination means for determining whether or not a warning is necessary, on the basis of a result of the character recognition and specification information of the vehicle; and
an output means for outputting warning information in a case where it is determined that the warning is necessary.

A warning system according to a second aspect of the present disclosure includes:
an imaging means for imaging surroundings of a vehicle;
a region recognition means for recognizing a region included in an image captured by the imaging means while the vehicle is traveling;
a first determination means for determining whether or not character recognition is necessary, on the basis of a type of the recognized region;
a character recognition means for performing the character recognition on the recognized region in a case where it is determined that the character recognition is necessary;
a second determination means for determining whether or not a warning is necessary, on the basis of a result of the character recognition and specification information of the vehicle; and
an output means for outputting warning information in a case where it is determined that the warning is necessary.

A warning method according to a third aspect of the present disclosure includes:
by a computer,
recognizing a region included in an image obtained by imaging surroundings of a traveling vehicle;
determining whether or not character recognition is necessary, on the basis of a type of the recognized region;
performing the character recognition on the recognized region in a case where it is determined that the character recognition is necessary;
determining whether or not a warning is necessary, on the basis of a result of the character recognition and specification information of the vehicle; and
outputting warning information in a case where it is determined that the warning is necessary.

A non-transitory computer-readable medium having stored thereon a warning program according to a fourth aspect of the present disclosure causes a computer to execute:
region recognition processing for recognizing a region included in an image obtained by imaging surroundings of a traveling vehicle;
first determination processing for determining whether or not character recognition is necessary, on the basis of a type of the recognized region;
character recognition processing for performing the character recognition on the recognized region in a case where it is determined that the character recognition is necessary;
second determination processing for determining whether or not a warning is necessary, on the basis of a result of the character recognition and specification information of the vehicle; and
output processing for outputting warning information in a case where it is determined that the warning is necessary.

### Advantageous Effects of Invention

According to the present disclosure, it is possible to provide the warning apparatus, the system, the method, and the program for improving accuracy of the warning regarding the traveling vehicle.

### BRIEF DESCRIPTION OF DRAWINGS

FIG. 1 is a block diagram illustrating a configuration of a warning apparatus according to a first example embodiment.

FIG. 2 is a flowchart illustrating a flow of a warning method according to the first example embodiment.

FIG. 3 is a block diagram illustrating a configuration of a warning system according to a second example embodiment.

FIG. 4 is a flowchart illustrating a flow of warning processing according to the second example embodiment.

FIG. 5 is a diagram illustrating an example of a captured image according to the second example embodiment.

FIG. 6 is a diagram illustrating an example of the captured image according to the second example embodiment.

FIG. 7 is a flowchart illustrating a flow of warning processing according to a third example embodiment.

FIG. 8 is a flowchart illustrating a flow of warning processing according to a fourth example embodiment.

FIG. 9 is a block diagram illustrating a configuration of a warning system according to a fifth example embodiment.

FIG. 10 is a sequence diagram illustrating a flow of the warning processing according to the fifth example embodiment.

### EXAMPLE EMBODIMENT

Hereinafter, example embodiments of the present disclosure will be described in detail with reference to the drawings. In the drawings, the same or corresponding elements are denoted by the same reference signs, and repeated description of the elements will be omitted to clarify the description as necessary.

### First Example Embodiment

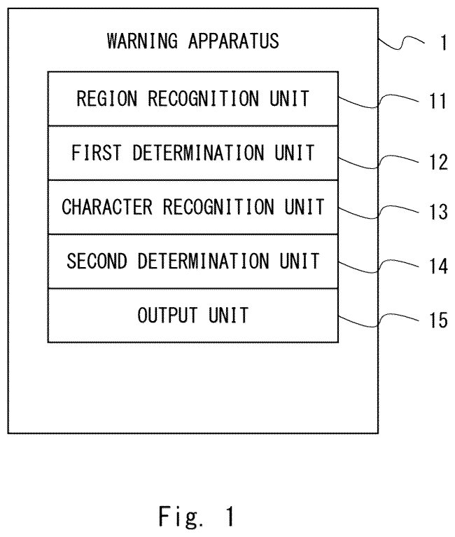

FIG. 1 is a block diagram illustrating a configuration of a warning apparatus 1 according to the first example embodiment. The warning apparatus 1 is an information processing apparatus for issuing a warning to avoid a collision accident between a vehicle and a structure on a road. The warning apparatus 1 includes a region recognition unit 11, a first determination unit 12, a character recognition unit 13, a second determination unit 14, and an output unit 15. The region recognition unit 11 recognizes a region included in an image obtained by imaging surroundings of a traveling vehicle. Here, region recognition processing of recognizing a region is processing of dividing a set of coordinates in image data into a plurality of regions according to a shape, a pixel value, or the like, and specifying a type of each region. Note that a known technique may be used for the region recognition processing. The first determination unit 12 determines whether or not character recognition is necessary, on the basis of a type of the region recognized by the region recognition unit 11. In a case where it is determined that the character recognition is necessary, the character recognition unit 13 performs the character recognition on the recognized region. Note that the character recognition processing may use a known technique. The second determination unit 14 determines whether or not a warning is necessary, on the basis of the result of the character recognition and specification information regarding the vehicle. Here, the specification information regarding the vehicle is, for example, information indicating vehicle specifications such as a vehicle height, a vehicle width, and a weight. In a case where it is determined that a warning is necessary, the output unit 15 outputs warning information.

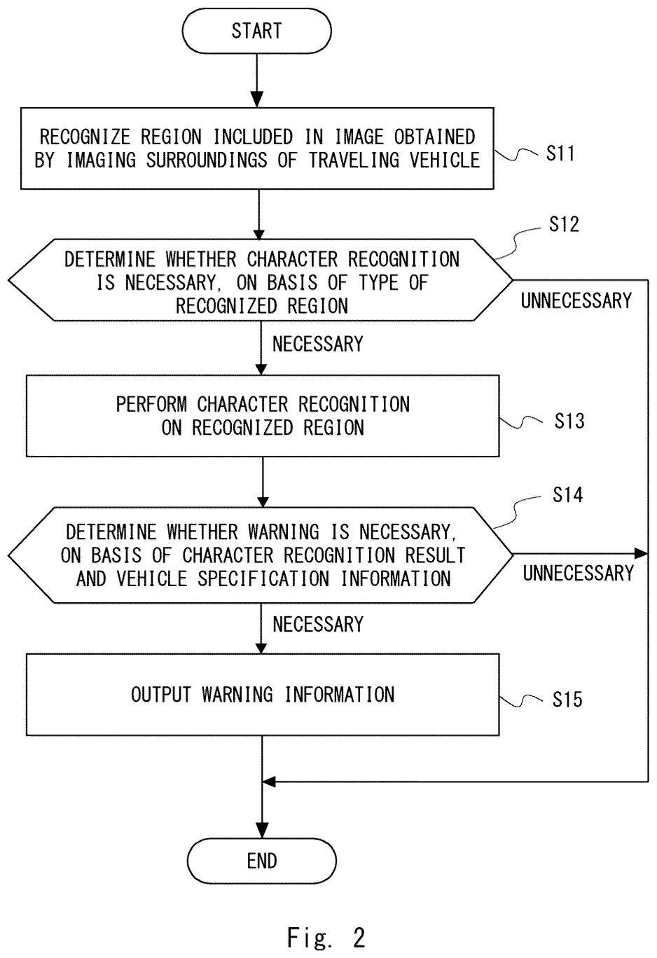

FIG. 2 is a flowchart illustrating a flow of a warning method according to the first example embodiment. First, the region recognition unit 11 recognizes a region included in an image obtained by imaging surroundings of a traveling vehicle (S11). Next, the first determination unit 12 determines whether or not the character recognition is necessary, on the basis of a type of the recognized region (S12). For example, in a case where the type of the recognized region corresponds to a specific type, the first determination unit 12 may determine that character recognition is necessary. In a case where it is determined in step S12 that the character recognition is necessary, the character recognition unit 13 performs the character recognition on the recognized region (S13). Then, the second determination unit 14 determines whether or not the warning is necessary, on the basis of the result of the character recognition and specification information regarding the vehicle (S14). For example, in a case where the character recognition result includes a threshold of the specification information, and the specification information of the corresponding vehicle exceeds the threshold, the second determination unit 14 may determine that the warning is necessary. In a case where it is determined in step S14 that the warning is necessary, the output unit 15 outputs warning information (S15). Note that, in a case where it is determined in step S12 or S14 that the warning is unnecessary, there is no need to output the warning information.

As described above, in the present example embodiment, whether or not the character recognition is necessary is determined based on the type of the region recognized from an image of an outside of the vehicle captured during traveling, and the character recognition is performed after an image suitable for the character recognition is selected. Therefore, meaningful character recognition can be efficiently performed, and constraint information of the specification information regarding the vehicle can be easily recognized accurately. Therefore, the necessity determination for the warning can be performed more accurately, and the accuracy of the warning regarding the traveling vehicle can be improved.

Note that the warning apparatus 1 includes a processor, a memory, and a storage device as components not illustrated. In addition, the storage device stores a computer program in which the processing of the warning method according to the present example embodiment is implemented. Then, the processor reads the computer program or the like from the storage device into the memory and executes the computer program. As a result, the processor implements the functions of the region recognition unit 11, the first determination unit 12, the character recognition unit 13, the second determination unit 14, and the output unit 15.

Alternatively, each constituent of the warning apparatus 1 may be implemented by dedicated hardware. Some or all of the constituents of each apparatus may be implemented by a general-purpose or dedicated circuitry, a processor, or a combination thereof. These constituents may be configured with a single chip or may be configured with a plurality of chips connected via a bus. Some or all of the constituents of each apparatus may be implemented by a combination of the above circuitry or the like and a program. As the processor, a central processing unit (CPU), a graphics processing unit (GPU), a field-programmable gate array (FPGA), a quantum processor (quantum computer control chip), or the like may be used.

In addition, in a case where some or all of the constituents of the warning apparatus 1 are implemented by a plurality of information processing apparatuses, circuitries, and the like, the plurality of information processing apparatuses, circuitries, and the like may be arranged in a centralized manner or in a distributed manner. For example, the information processing apparatuses, the circuitries, or the like may be implemented in a form of a system in which a client server system, a cloud computing system, and the like are connected to each other via a communication network. In addition, the function of the warning apparatus 1 may be provided in a Software as a Service (Saas) format.

### Second Example Embodiment

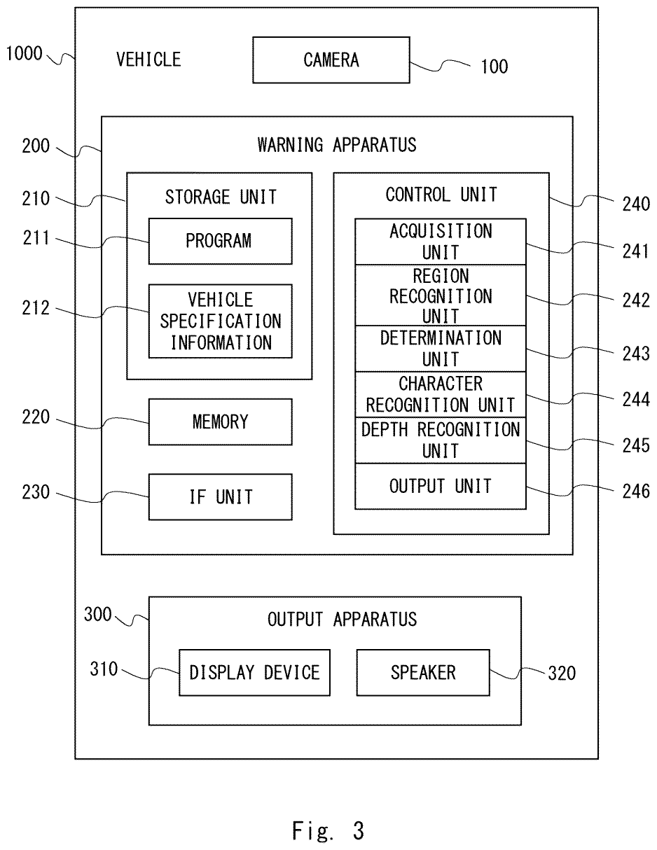

A second example embodiment is a specific example of the first example embodiment described above. FIG. 3 is a block diagram illustrating a configuration of a warning system according to the second example embodiment. Here, a vehicle 1000 is illustrated as an example of the warning system. The vehicle 1000 includes a camera 100, a warning apparatus 200, and an output apparatus 300. The camera 100 is an example of an imaging means which images surroundings of the vehicle 1000. The surroundings of the vehicle 1000 is the outside of the vehicle 1000, for example, a front, rear, side, and the like of the vehicle 1000, and may include at least a part thereof. The camera 100 is preferably a so-called in-vehicle camera. The output apparatus 300 is an apparatus which outputs warning information generated by the warning apparatus 200. The output apparatus 300 includes, for example, a display device 310 and a speaker 320. The display device 310 is a display or the like installed in a vehicle, and may be a display for car navigation. The speaker 320 outputs a warning sound. In addition, the output apparatus 300 may include a warning lamp or the like.

The warning apparatus 200 is a so-called in-vehicle apparatus and is an example of the warning apparatus 1 described above. The warning apparatus 200 is an information processing apparatus that performs the region recognition, the character recognition, and depth recognition on the image of the outside of the vehicle captured by the camera 100, and in a case where the warning is necessary, outputs the warning information via the output apparatus 300. The warning apparatus 200 may be implemented by an electronic control unit (ECU) mounted on the vehicle 1000. Alternatively, the warning apparatus 200 may be redundant in a plurality of servers, and each functional block may be implemented by a plurality of computers.

The warning apparatus 200 includes a storage unit 210, a memory 220, an interface (IF) unit 230, and a control unit 240. The storage unit 210 is an example of a storage device such as a hard disk or a flash memory. The storage unit 210 stores a program 211 and vehicle specification information 212. The program 211 is a computer program (warning program) in which warning processing or the like according to the second example embodiment are implemented. The vehicle specification information 212 is information indicating vehicle specifications such as a vehicle height, a vehicle width, and a weight of the vehicle 1000.

The memory 220 is a volatile storage device such as a random access memory (RAM), and is a storage region for temporarily holding information during the operation of the control unit 240. The IF unit 230 is a communication interface between the inside of the warning apparatus 200 and the camera 100 and the output apparatus 300.

The control unit 240 is a processor that controls each component of the warning apparatus 200, that is, a control apparatus. The control unit 240 reads the program 211 from the storage unit 210 into the memory 220 and executes the program 211. As a result, the control unit 240 implements functions of an acquisition unit 241, a region recognition unit 242, a determination unit 243, a character recognition unit 244, a depth recognition unit 245, and an output unit 246.

The acquisition unit 241 acquires an image captured by the camera 100 while the vehicle 1000 is traveling. Note that the acquisition unit 241 may acquire a traveling speed from a speed meter or the like of vehicle 1000.

The region recognition unit 242 is an example of the region recognition unit 11 described above. The region recognition unit 242 performs the region recognition on the image acquired by the acquisition unit 241. Here, the region recognition unit 242 divides the image data into a plurality of regions by shape recognition, color identification, or the like, on the basis of a shape of a predetermined region that is a set of adjacent pixels in the image data or a pixel value of each pixel, and determines a type of each region. The region is a set of two-dimensional coordinates of adjacent pixels in the image data. The type is a road, a sidewalk, a pedestrian, a street lamp, a road sign, a plate, an elevated bridge, a pedestrian bridge, a street tree, or the like, and is not limited thereto.

The determination unit 243 is an example of the first determination unit 12 and the second determination unit 14 described above. The determination unit 243 determines whether or not the type of each region recognized by the region recognition unit 242 corresponds to a specific type. Here, the specific type is a type of a region that may include traffic restriction information written with characters, symbols, figures, or the like for restricting passage of the vehicle 1000. Examples of the specific type include, but are not limited to, a street lamp, a road sign, a card, an elevated bridge, a pedestrian bridge, and the like. The specific type is a part of the type that can be recognized by the region recognition unit 242, and may be set in the storage unit 210 in advance. Then, in a case where the recognized type of the region corresponds to the specific type, the determination unit 243 determines that the character recognition is necessary. This is because, in a case where the type of the region is a street lamp, a road sign, a card, an elevated bridge, a pedestrian bridge, or the like, a possibility that the passage restriction information is described is high, and thus, an accuracy of the character recognition can be increased.

In addition, the determination unit 243 determines whether or not the warning is necessary, on the basis of at least one of a result of the character recognition by the character recognition unit 244 described later and a result of the depth recognition by the depth recognition unit 245 described later, and the vehicle specification information 212. In a case where there is the character recognition result, and the vehicle specification information 212 exceeds a threshold included in the character recognition result, the determination unit 243 determines that the warning is necessary. In a case where there is the depth recognition result, and the vehicle specification information 212 exceeds a threshold of the specification information calculated from the depth recognition result, the determination unit 243 determines that the warning is necessary. In addition, the determination unit 243 may determine whether or not the warning is necessary, on the basis of the character recognition result, the depth recognition result, the region recognition result, and the vehicle specification information 212. Note that in addition to the above, the determination unit 243 may determine whether or not the warning is necessary, in consideration of the traveling speed of vehicle 1000.

The character recognition unit 244 is an example of the character recognition unit 13 described above. The character recognition unit 244 performs the character recognition on a region corresponding to the specific type, and outputs a character recognition result to the determination unit 243.

The depth recognition unit 245 performs the depth recognition on the region recognized by the region recognition unit 242. Here, the depth recognition refers to processing of calculating a distance to a recognition target object for each part of the image data. For example, the depth recognition unit 245 may calculate, as a depth, a distance between the camera 100 and the recognition target object, based on a color intensity of each pixel in the image data. Note that the depth recognition processing may use a known technique. Furthermore, the depth recognition unit 245 may calculate the threshold of the specification information from the calculated depth and the region recognition result, and output the threshold to the determination unit 243 as the depth recognition result. That is, the depth recognition unit 245 may combine the depth recognition result and the region recognition result to recognize a three-dimensional positional relationship and a distance between the vehicle 1000 and a recognition target region (the recognition target object or the like). For example, the depth recognition unit 245 may calculate a height, a width, or the like of the recognition target object from the recognized distance and calculate the threshold of the specification information by using these.

Furthermore, the depth recognition unit 245 may perform the depth recognition on a region, which is within a predetermined range including a center of the image, among the recognized regions. As a result, by prioritizing the depth recognition in a region where the vehicle 1000 is more likely to collide, the recognition processing for a region with a low possibility of collision can be avoided, and the recognition processing can be made efficiently. In addition, the depth recognition unit 245 performs the depth recognition regardless of the necessity of the character recognition. Alternatively, in a case where the type of the recognized region corresponds to the specific type, the depth recognition unit 245 may perform the depth recognition. That is, the depth recognition unit 245 may perform the depth recognition on a target region of the character recognition.

The output unit 246 is an example of the output unit 15 described above. The output unit 246 generates warning information on the basis of the region recognition result, the character recognition result, and the depth recognition result, and outputs the warning information via the output apparatus 300. For example, in a case where the character recognition is performed, the output unit 246 may generate and output warning information corresponding to the character recognition result.

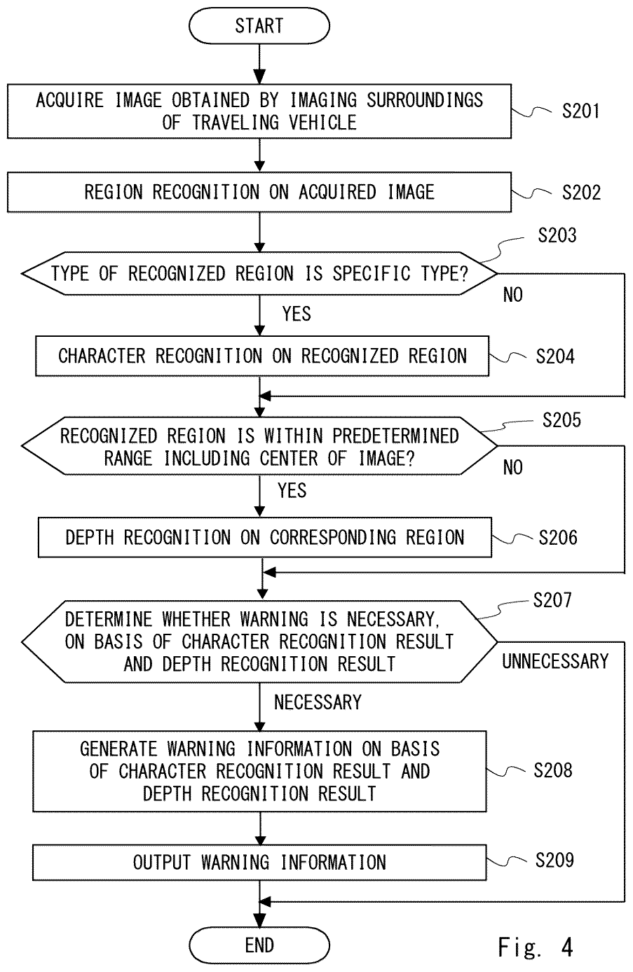

FIG. 4 is a flowchart illustrating a flow of warning processing according to the second example embodiment. As a premise, the camera 100 captures an image of the outside of the vehicle 1000 while the vehicle 1000 is traveling, and outputs the captured image data to the warning apparatus 200. In response to this, the acquisition unit 241 of the warning apparatus 200 acquires an image obtained by imaging the surroundings of the traveling vehicle 1000 (S201). Then, the region recognition unit 242 performs the region recognition on the acquired image (S202). At this time, the region recognition unit 242 divides the image data into a plurality of regions (specifies regions) on the basis of a shape, a color, or the like of displayed content in the image, and recognizes a type for each region. That is, the region recognition unit 242 assigns the recognized type (such as a label) to each of the plurality of recognized regions (sets of two-dimensional coordinates).

Then, the determination unit 243 determines whether or not the recognized type of each region is the specific type (S203). That is, the determination unit 243 determines whether or not the type assigned to each of the plurality of regions is a preset specific type. In step S203, for a region determined to be the specific type among the plurality of regions, step S204 is processed, and for a region determined to be other than the specific type, the process proceeds to step S205.

Subsequently, the character recognition unit 244 performs the character recognition on the recognized region (the region determined to be the specific type) (S204). Then, the character recognition unit 244 outputs, as the character recognition result, a character string recognized from the region to the determination unit 243.

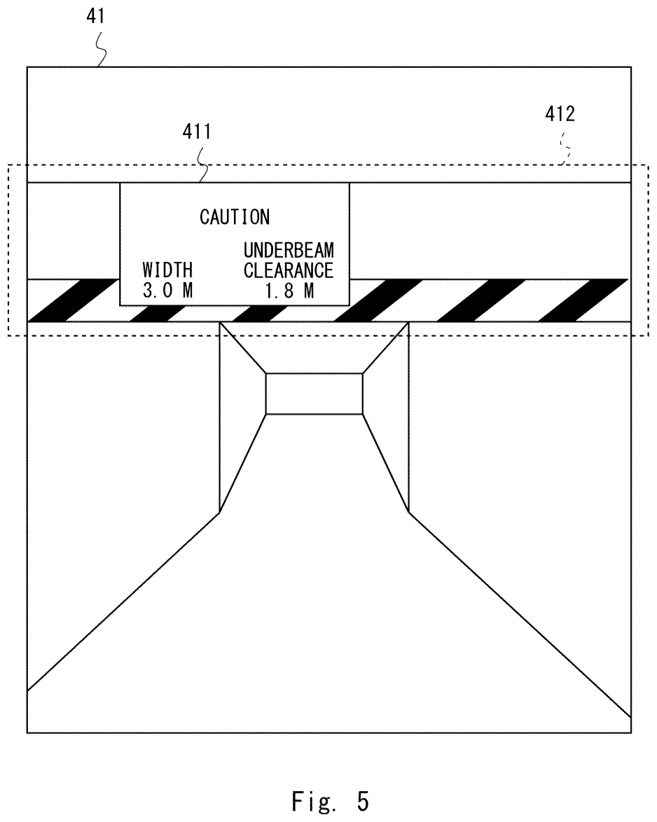

FIG. 5 is a diagram illustrating an example of a captured image 41 according to the second example embodiment. The image 41 is an example of an image obtained by imaging a traveling direction of the vehicle 1000. In the image 41, an elevated bridge 412 is illustrated as an example of the recognized region. The elevated bridge 412 is an example of a region determined to be a specific type “elevated bridge”. Then, a plate 411 is included in the region of the elevated bridge 412. The plate 411 is an example of a region determined to be a specific type “road sign”. The plate 411 indicates that character strings corresponding to the traffic restriction information such as “Width 3.0 M” and “Underbeam Clearance 1.8 M” are written.

In the example of FIG. 5, the character recognition unit 244 performs the character recognition processing on the region of the elevated bridge 412 or the plate 411. As a result, the character recognition unit 244 recognizes character strings such as “Width 3.0 M” or “Underbeam Clearance 1.8 M”, and recognizes a vehicle width threshold as “3.0 M” and a vehicle height threshold as “1.8 M” in the specification information from the recognized character strings. Then, for example, the character recognition unit 244 outputs, as the character recognition results, “3.0 M” as the vehicle width threshold and “1.8 M” as the vehicle height threshold to the determination unit 243. Note that since the character recognition unit 244 does not perform the character recognition processing on a region other than the elevated bridge 412 in the image 41, unnecessary recognition processing can be suppressed, and the accuracy of character recognition can be improved. In addition, by performing the character recognition processing on the region of the plate 411, the character recognition unit 244 has a higher accuracy in the character recognition, compared to the character recognition processing on the elevated bridge 412.

For the region for which the character recognition processing has been performed in step S204 and the region which is determined in step S203 to be other than the specific type, the determination unit 243 determines whether or not the recognized region is within a predetermined range including the center of the image (S205).

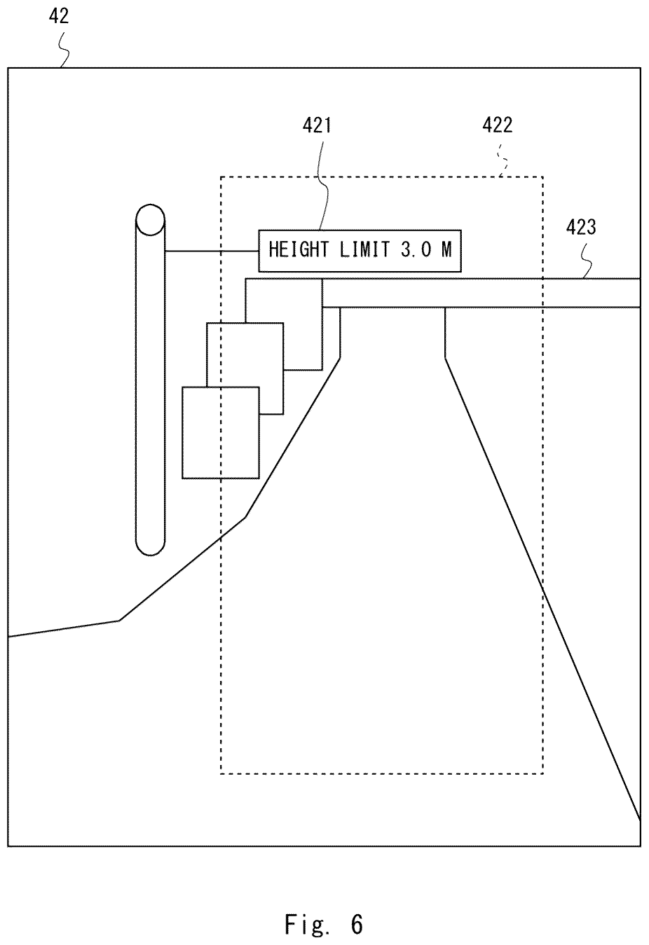

The depth recognition unit 245 performs the depth recognition on the corresponding region (S206). FIG. 6 is a diagram illustrating an example of a captured image 42 according to the second example embodiment. The image 42 is an example of the image obtained by imaging the traveling direction of vehicle 1000. In the image 42, a sign 421 and an elevated bridge 423 are illustrated as an example of the recognized region. In addition, a center region 422 is an example of the predetermined range including the center of the image 42. Therefore, the depth recognition unit 245 performs the depth recognition on each of the sign 421 and the elevated bridge 423, and outputs a depth recognition result to the determination unit 243. At this time, the depth recognition unit 245 calculates a distance between the sign 421 or the elevated bridge 423 and the vehicle 1000, and calculates a height or the like of the sign 421 or the elevated bridge 423 on the basis of a position of the region in the image 42 on the two-dimensional coordinates and the calculated distance. The depth recognition unit 245 sets the calculated height and the like as a threshold of the specification information. In the example of FIG. 6, the depth recognition unit 245 calculates a height “3.0 M” of the sign 421 from the road and calculates a height “3.0 M” of the elevated bridge 423 from the road, sets the vehicle height threshold to “3.0 M”, and outputs, as the depth recognition result, the vehicle height threshold to the determination unit 243.

For the region for which the depth recognition processing has been performed in step S206 and the region which is determined in step S205 to be out of the predetermined range, the determination unit 243 determines whether or not the warning is necessary, on the basis of at least one of the character recognition result or the depth recognition result (S207). Specifically, the determination unit 243 determines whether or not the warning is necessary, on the basis of the character recognition result, the depth recognition result, the region recognition result, and the vehicle specification information 212. Furthermore, the determination unit 243 may determine whether or not the warning is necessary, in consideration of the traveling speed of the vehicle 1000.

In a case where it is determined in step S207 that the warning is necessary, the output unit 246 generates warning information on the basis of at least one of the character recognition result or the depth recognition result (S208). Specifically, the output unit 246 may generate, as the warning information, a message indicating a caution alert or detour request, including the threshold of the specification information included in the character recognition result. Note that the warning information may be a warning sound or both a warning sound and a message. The output unit 246 outputs the warning information to the output apparatus 300 (S209).

For example, in the example of FIG. 5, the output unit 246 may generate, as the warning information, a message such as “vehicle width limit: 3.0 M, vehicle height limit: 1.8 M, please drive with caution”, and the display device 310 may display the message on a screen. Alternatively, the output unit 246 may generate, as the warning information, a message such as “vehicle width limit: 3.0 M, vehicle height limit: 1.8 M, passage is not allowed for this vehicle, please take a detour” and a warning sound, the display device 310 may display the message on the screen, and the speaker 320 may output the warning. Note that after step S209 or in a case where it is determined in step S207 that the warning is unnecessary, the warning processing may be ended, or the process may return to step S201 to continue the warning processing.

As described above, according to the present example embodiment, it is possible to improve the accuracy of the warning regarding the traveling vehicle, similarly to the first example embodiment described above. In particular, in the present example embodiment, since whether or not the warning is necessary is determined using the depth recognition result in addition to the character recognition result, the accuracy of the warning can be improved. In addition, even in a case where it is determined based on the region recognition result that the character recognition is unnecessary (NO in step S203), the depth recognition is performed, so that it is possible to accurately determine whether or not the warning is necessary, by using the region recognition result and the depth recognition result. Furthermore, since the depth recognition is performed within a predetermined range in the image, it is possible to reduce the load of the depth recognition processing in the region with a low collision probability of the vehicle.

### Third Example Embodiment

A third example embodiment is a modified example of the second example embodiment described above. The depth recognition unit according to the third example embodiment performs the depth recognition in a case where it is determined that the character recognition is unnecessary. Note that the other configurations and processing according to the third example embodiment are similar to those of the above-described second example embodiment, and thus repeated description and illustration thereof will be omitted.

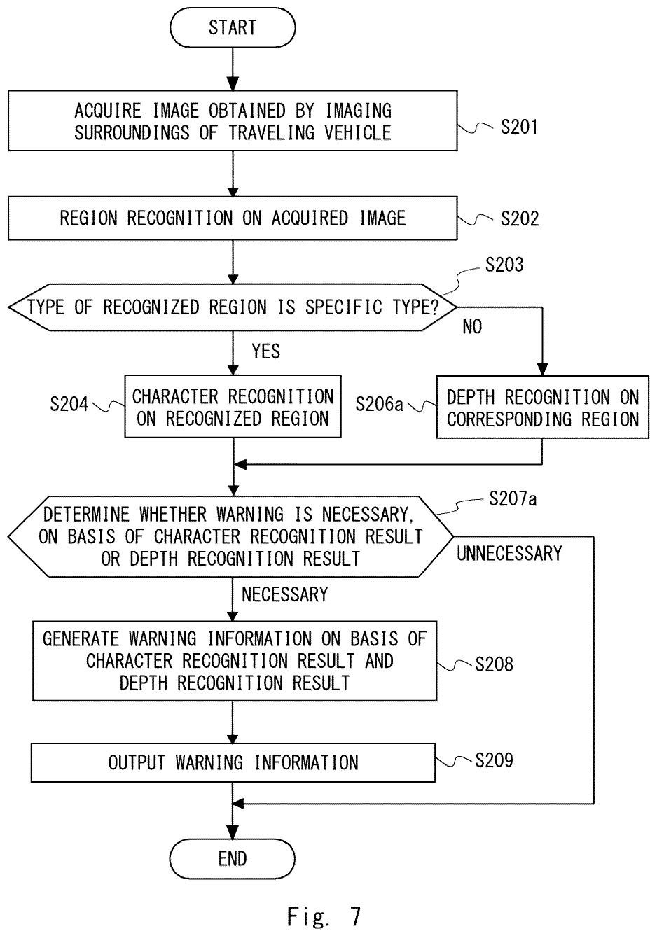

FIG. 7 is a flowchart illustrating a flow of the warning processing according to the third example embodiment. In FIG. 7, as compared with FIG. 4 described above, in a case where the type of the region recognized in step S203 is not the specific type, the depth recognition unit 245 performs the depth recognition on the corresponding region (the region that is not of the specific type) (S206a). Note that specific processing in step S206a is similar to that in step S206 described above.

After step S204 or S206a, the determination unit 243 determines whether or not the warning is necessary, on the basis of either the character recognition result or the depth recognition result (S207a). In a case where it is determined that the warning is necessary, the output unit 246 processes steps S208 and S209 described above, and in a case where it is determined that the warning is unnecessary, the warning processing is ended or the process returns to step S201, similar to after step S209.

As described above, in the third example embodiment, since the depth recognition is performed even in a case where it is determined based on the region recognition result that the character recognition is unnecessary, it is possible to accurately determine whether or not the warning is necessary, by using the region recognition result and the depth recognition result. Additionally, according to the third example embodiment, it is possible to obtain the same effects as those of the above-described second example embodiment.

### Fourth Example Embodiment

A fourth example embodiment is a modified example of the second or third example embodiment described above. In a case where it is determined that the character recognition is necessary, the character recognition unit according to the fourth example embodiment performs the character recognition by using a recognition algorithm corresponding to the type of the recognized region. Therefore, for example, it is assumed that the storage unit 210 of the warning apparatus 200 stores each of a plurality of kinds of specific types in association with (identification information of) a corresponding recognition algorithm. In addition, the character recognition unit 244 can execute a plurality of kinds of designated recognition algorithms. Note that the other configurations and processing according to the fourth example embodiment are similar to those of the above-described second example embodiment, and thus repeated description and illustration thereof will be omitted.

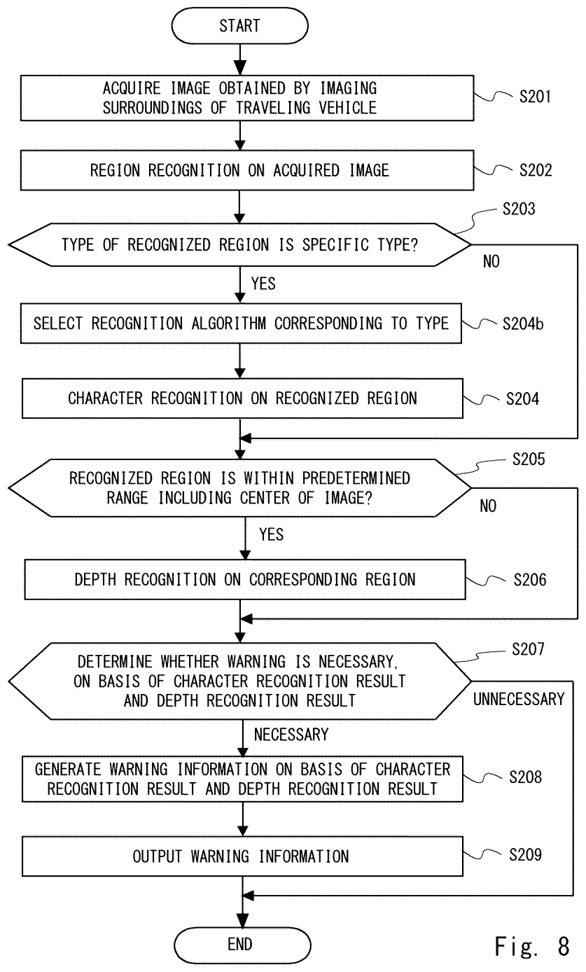

FIG. 8 is a flowchart illustrating a flow of the warning processing according to the fourth example embodiment. In FIG. 8, as compared with FIG. 4 described above, step S204b is added before step S204. Specifically, in a case where there is a region determined to be any of a plurality of kinds of specific types in step S203, the character recognition unit 244 selects a recognition algorithm corresponding to the recognized (determined) type (S204b). Then, the character recognition unit 244 performs the character recognition on the region recognized as the specific type, by using the selected recognition algorithm (S205). The subsequent processing is similar to that in FIG. 4 described above. In addition, step S204b may be executed before step S204 in FIG. 7 described above.

As described above, in the fourth example embodiment, a recognition algorithm with high recognition efficiency is set in advance for the type of the recognized region, and the character recognition can be performed using an appropriate recognition algorithm corresponding to the recognized specific type. For example, character recognition processing specialized for recognition of the position of the plate 411 in the elevated bridge 412 and a character string to be described, recognition processing specialized for recognition of an outer shape (circle), a symbol, a shape, and a color of the sign 421 and recognition of a character string to be described, and the like can be selectively performed. Therefore, the recognition processing load can be reduced, and the recognition efficiency and the recognition accuracy can be further improved.

### Fifth Example Embodiment

A fifth example embodiment is another specific example of the first example embodiment described above and is a modified example of the second to fourth example embodiments. A warning apparatus according to the fifth example embodiment is installed outside a vehicle and performs wireless communication with the vehicle.

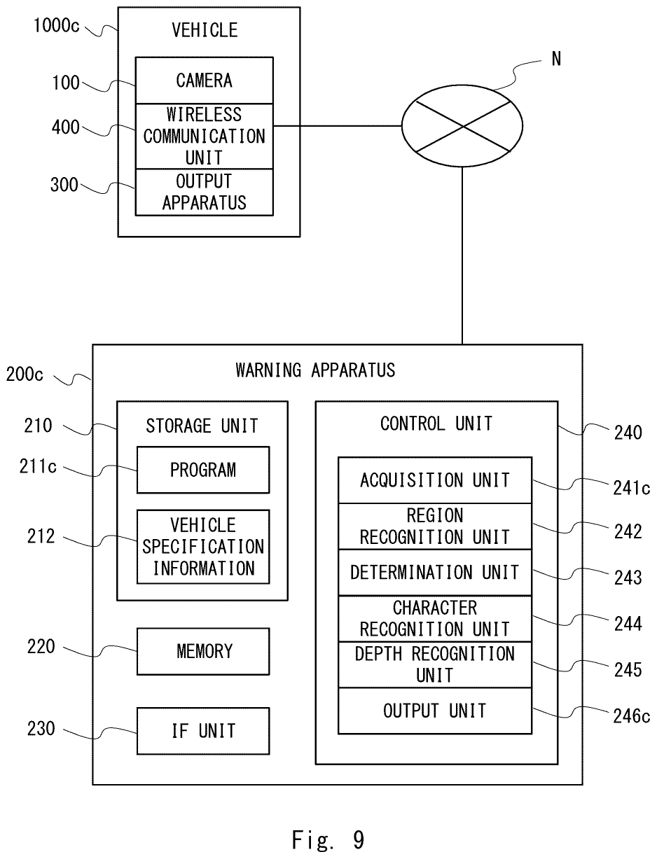

FIG. 9 is a block diagram illustrating a configuration of a warning system according to the fifth example embodiment. In the warning system, a vehicle 1000c and a warning apparatus 200c are connected via a network N. The network N is a communication network including a wireless communication line. Specifically, the network N includes, for example, the Internet, a wireless communication line network, a mobile phone line network, and the like. In addition, the network N may be of any type of communication protocol.

The vehicle 1000c includes the camera 100, a wireless communication unit 400, and the output apparatus 300. The camera 100 and the output apparatus 300 are similar to those in FIG. 3 described above. The wireless communication unit 400 transmits an image captured by the camera 100 to the warning apparatus 200c via the network N by wireless communication, and outputs, to the output apparatus 300, warning information received from the warning apparatus 200c via the network N by wireless communication.

Compared to the warning apparatus 200 described above, the warning apparatus 200c has a program 211c, an acquisition unit 241c, and an output unit 246c, which have been replaced. The other configurations are similar to those of the warning apparatus 200 described above, and thus the description thereof is appropriately omitted. The program 211c is a computer program (warning program) in which warning processing or the like according to the fifth example embodiment are implemented.

By wireless communication from the vehicle 1000c via the network N, the acquisition unit 241c acquires the image captured by the camera 100 while the vehicle 1000c is traveling. Note that the acquisition unit 241 may also acquire the traveling speed of the vehicle 1000c.

The output unit 246c outputs the warning information by wireless communication via the network N to the vehicle 1000c, in order to cause the output apparatus 300 to output the warning information.

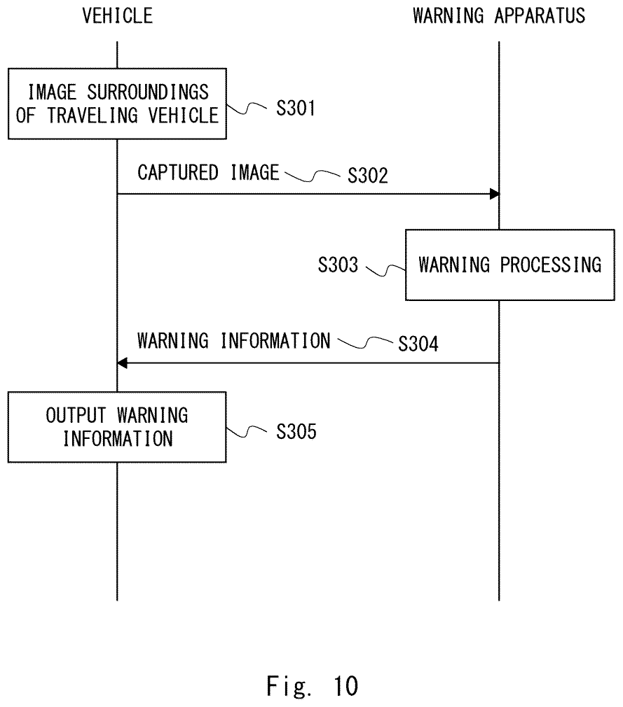

FIG. 10 is a sequence diagram illustrating a flow of the warning processing according to the fifth example embodiment. First, the camera 100 of the vehicle 1000c images surroundings of the traveling vehicle 1000c (S301). Then, the wireless communication unit 400 of the vehicle 1000c transmits the captured image to the warning apparatus 200c via the network N (S302). In response to this, the acquisition unit 241c of the warning apparatus 200c acquires the captured image from the warning apparatus 200c. Then, the warning apparatus 200c executes the warning processing as in steps S202 to S209 in FIG. 4 described above (S303). Then, the output unit 246c of the warning apparatus 200c transmits the generated warning information to the vehicle 1000c via the network N (S304). In response to this, the wireless communication unit 400 of the vehicle 1000c receives the warning information from the warning apparatus 200c via the network N. Then, the output apparatus 300 outputs the received warning information (S305).

As described above, according to the present example embodiment, it is possible to improve the accuracy of the warning regarding the traveling vehicle, similarly to the first example embodiment described above. In particular, in the present example embodiment, instead of the in-vehicle apparatus, a server installed outside the vehicle can be used as the warning apparatus. Therefore, the processing load of the in-vehicle apparatus can be reduced. In addition, in a case where the vehicle is caused to travel by automatic driving, it is easy to add or change advanced processing on the server side. Therefore, the warning apparatus according to the present example embodiment can be easily introduced.

### Other Example Embodiment

Note that each of the above-described example embodiments may have the following configuration. For example, in order to generate warning map information to be provided to another vehicle having specification information similar to that of the vehicle within a predetermined range, the output unit may output an image capturing position and the warning information in a case where it is determined that a warning is necessary. For example, the acquisition unit may acquire the image capturing position acquired together with the image. Then, the output unit may register a set of position information indicating the capturing position and the warning information in a generation server of the warning map information or a generation database. Note that the output unit may register a set of the position information and the warning information in real time during traveling or during the vehicle is parked or stopped. As a result, by matching data, which is collected by actual traveling of the vehicle, such as a height of an elevated bridge, a road sign, a street tree, or the like, or a width of a road (tunnel) with the position information, map information in which information on a place where the vehicle is likely to collide is accumulated can be created. Then, by sharing the map information between vehicles having the same specification information, before the image recognition processing is performed, a warning is issued early in a case where the vehicle approaches a point having a high collision probability, so that it is possible to support earlier and precise collision avoidance.

In addition, in a case where it is determined that the warning is necessary, the output unit may output the warning information to the outside of the vehicle. As a result, the warning information can be shared with or a warning can be issued to pedestrians, bicycles, vehicles, and the like around the vehicle. For example, in a case where it is found that the vehicle cannot pass under an elevated bridge ahead and the vehicle makes an emergency stop or sharp turn, it is easy to prevent a collision accident with the surroundings.

### Other Example Embodiment

In the above-described example, the program includes a group of instructions (or software code) for causing a computer to perform one or more functions described in the example embodiments in a case where the program is read by the computer. The program may be stored in a non-transitory computer readable medium or a tangible storage medium. As an example and not by way of limitation, the computer readable medium or the tangible storage medium includes a random access memory (RAM), a read only memory (ROM), a flash memory, a solid-state drive (SSD) or any other memory technology, a CD-ROM, a digital versatile disc (DVD), a Blu-ray (registered trademark) disc or any other optical disk storage, a magnetic cassette, a magnetic tape, a magnetic disk storage, and any other magnetic storage device. The program may be transmitted through a transitory computer readable medium or a communication medium. By way of example, and not limitation, transitory computer-readable or communication media include electrical, optical, acoustic, or other forms of propagated signals.

Note that the present disclosure is not limited to the above example embodiments, and can be appropriately changed without departing from the gist. In addition, the present disclosure may be implemented by appropriately combining the example embodiments.

The whole or part of the example embodiments disclosed above can be described as, but not limited to, the following supplementary notes.
Supplementary Note A1

A warning apparatus including:
a region recognition means for recognizing a region included in an image obtained by imaging surroundings of a traveling vehicle;
a first determination means for determining whether or not character recognition is necessary, on the basis of a type of the recognized region;
a character recognition means for performing the character recognition on the recognized region in a case where it is determined that the character recognition is necessary;
a second determination means for determining whether or not a warning is necessary, on the basis of a result of the character recognition and specification information of the vehicle; and
an output means for outputting warning information in a case where it is determined that the warning is necessary.
Supplementary Note A2

The warning apparatus according to Supplementary Note A1, further including a depth recognition means for performing depth recognition on the recognized region,
in which the second determination means further determines whether or not the warning is necessary, on the basis of a result of the depth recognition.
Supplementary Note A3

The warning apparatus according to Supplementary Note A2, in which the depth recognition means performs the depth recognition in a case where it is determined that the character recognition is unnecessary.
Supplementary Note A4

The warning apparatus according to Supplementary Note A2 or A3, in which the depth recognition means performs the depth recognition on a region, which is within a predetermined range including a center of the image, among the recognized regions.
Supplementary Note A5

The warning apparatus according to any one of Supplementary Notes A2 to A4, in which the depth recognition means performs the depth recognition in a case where a type of the recognized region corresponds to a specific type.
Supplementary Note A6

The warning apparatus according to any one of Supplementary Notes A1 to A5, in which the first determination means determines that the character recognition is necessary, in a case where a type of the recognized region corresponds to a specific type.
Supplementary Note A7

The warning apparatus according to any one of Supplementary Notes A1 to A6, in which the output means outputs a capturing position of the image and the warning information in a case where it is determined that the warning is necessary, in order to generate warning map information to be provided to another vehicle having the specification information similar to that of the vehicle within a predetermined range.
Supplementary Note A8

The warning apparatus according to any one of Supplementary Notes A1 to A7, in which the output means outputs the warning information to an outside of the vehicle, in a case where it is determined that the warning is necessary.
Supplementary Note A9

The warning apparatus according to any one of Supplementary Notes A1 to A8, in which the character recognition means performs the character recognition by using a recognition algorithm corresponding to a type of the recognized region, in a case where it is determined that the character recognition is necessary.
Supplementary Note A10

The warning apparatus according to any one of Supplementary Notes A1 to A9, in which the output means outputs the warning information corresponding to the result of the character recognition, in a case where it is determined that the warning is necessary.
Supplementary Note B1

A warning system including:
an imaging means for imaging surroundings of a vehicle;
a region recognition means for recognizing a region included in an image captured by the imaging means while the vehicle is traveling;
a first determination means for determining whether or not character recognition is necessary, on the basis of a type of the recognized region;
a character recognition means for performing the character recognition on the recognized region in a case where it is determined that the character recognition is necessary;
a second determination means for determining whether or not a warning is necessary, on the basis of a result of the character recognition and specification information of the vehicle; and
an output means for outputting warning information in a case where it is determined that the warning is necessary.
Supplementary Note B2

The warning system according to Supplementary Note B1, further including a depth recognition means for performing depth recognition on the recognized region,
in which the second determination means determines whether or not the warning is necessary, in consideration of a result of the depth recognition.
Supplementary Note C1

A warning method including:
by a computer,
recognizing a region included in an image obtained by imaging surroundings of a traveling vehicle;
determining whether or not character recognition is necessary, on the basis of a type of the recognized region;
performing the character recognition on the recognized region in a case where it is determined that the character recognition is necessary;
determining whether or not a warning is necessary, on the basis of a result of the character recognition and specification information of the vehicle; and
outputting warning information in a case where it is determined that the warning is necessary.
Supplementary Note D1

A non-transitory computer-readable medium having stored thereon a warning program for causing a computer to execute:
region recognition processing for recognizing a region included in an image obtained by imaging surroundings of a traveling vehicle;
first determination processing for determining whether or not character recognition is necessary, on the basis of a type of the recognized region;
character recognition processing for performing the character recognition on the recognized region in a case where it is determined that the character recognition is necessary;
second determination processing for determining whether or not a warning is necessary, on the basis of a result of the character recognition and specification information of the vehicle; and
output processing for outputting warning information in a case where it is determined that the warning is necessary.

Although the present invention has been described with reference to the example embodiments (and examples), the present invention is not limited to the above example embodiments (and examples). Various modified examples that can be understood by those skilled in the art can be made to the configuration and details of the present invention within the scope of the present invention.

### REFERENCE SIGNS LIST

1 WARNING APPARATUS
11 REGION RECOGNITION UNIT
12 FIRST DETERMINATION UNIT
13 CHARACTER RECOGNITION UNIT
14 SECOND DETERMINATION UNIT
15 OUTPUT UNIT
1000 VEHICLE
1000c VEHICLE
100 CAMERA
200 WARNING APPARATUS
200c WARNING APPARATUS
210 STORAGE UNIT
211 PROGRAM
211c PROGRAM
212 VEHICLE SPECIFICATION INFORMATION
220 MEMORY
230 IF UNIT
240 CONTROL UNIT
241 ACQUISITION UNIT
241c ACQUISITION UNIT
242 REGION RECOGNITION UNIT
243 DETERMINATION UNIT
244 CHARACTER RECOGNITION UNIT
245 DEPTH RECOGNITION UNIT
246 OUTPUT UNIT
246c OUTPUT UNIT
300 OUTPUT APPARATUS
310 DISPLAY DEVICE
320 SPEAKER
400 WIRELESS COMMUNICATION UNIT
N NETWORK
41 IMAGE
411 PLATE
412 ELEVATED BRIDGE
42 IMAGE
421 SIGN
422 CENTER REGION
423 ELEVATED BRIDGE

What is claimed is:

1. A warning apparatus comprising:
at least one memory storing instructions, and
at least one processor configured to execute the instructions to;
recognize a region included in an image obtained by imaging surroundings of a traveling vehicle;
determine whether or not character recognition is necessary, on the basis of a type of the recognized region;
perform the character recognition on the recognized region in a case where it is determined that the character recognition is necessary;
determine whether or not a warning is necessary, on the basis of a result of the character recognition and specification information of the vehicle; and
output warning information in a case where it is determined that the warning is necessary.

2. The warning apparatus according to claim 1, wherein the at least one processor is further configured to execute the instructions to;
perform depth recognition on the recognized region, and
determine whether or not the warning is necessary, on the basis of a result of the depth recognition.

3. The warning apparatus according to claim 2, wherein the at least one processor is further configured to execute the instructions to perform the depth recognition in a case where it is determined that the character recognition is unnecessary.

4. The warning apparatus according to claim 2, wherein the at least one processor is further configured to execute the instructions to perform the depth recognition on a region, which is within a predetermined range including a center of the image, among the recognized regions.

5. The warning apparatus according to claim 2, wherein the at least one processor is further configured to execute the instructions to perform the depth recognition in a case where a type of the recognized region corresponds to a specific type.

6. The warning apparatus according to claim 1, wherein the at least one processor is further configured to execute the instructions to determine that the character recognition is necessary, in a case where a type of the recognized region corresponds to a specific type.

7. The warning apparatus according to claim 1, wherein the at least one processor is further configured to execute the instructions to output a capturing position of the image and the warning information in a case where it is determined that the warning is necessary, in order to generate warning map information to be provided to another vehicle having the specification information similar to that of the vehicle within a predetermined range.

8. The warning apparatus according to claim 1, wherein the at least one processor is further configured to execute the instructions to output the warning information to an outside of the vehicle, in a case where it is determined that the warning is necessary.

9. The warning apparatus according to claim 1, wherein the at least one processor is further configured to execute the instructions to perform the character recognition by using a recognition algorithm corresponding to a type of the recognized region, in a case where it is determined that the character recognition is necessary.

10. The warning apparatus according to claim 1, wherein the at least one processor is further configured to execute the instructions to output the warning information corresponding to the result of the character recognition, in a case where it is determined that the warning is necessary.

11. A warning system comprising:
at least one memory storing instructions, and
at least one processor configured to execute the instructions to;
image surroundings of a vehicle;
recognize a region included in an image captured while the vehicle is traveling;
determine whether or not character recognition is necessary, on the basis of a type of the recognized region;
perform the character recognition on the recognized region in a case where it is determined that the character recognition is necessary;
determine whether or not a warning is necessary, on the basis of a result of the character recognition and specification information of the vehicle; and
output warning information in a case where it is determined that the warning is necessary.

12. The warning system according to claim 11, wherein the at least one processor is further configured to execute the instructions to;
perform depth recognition on the recognized region, and
determine whether or not the warning is necessary, in consideration of a result of the depth recognition.

13. A warning method comprising:
by a computer,
recognizing a region included in an image obtained by imaging surroundings of a traveling vehicle;
determining whether or not character recognition is necessary, on the basis of a type of the recognized region;
performing the character recognition on the recognized region in a case where it is determined that the character recognition is necessary;
determining whether or not a warning is necessary, on the basis of a result of the character recognition and specification information of the vehicle; and
outputting warning information in a case where it is determined that the warning is necessary.

14. (canceled)
